(19) United States
(12) Patent Application Publication
(10) Pub. No.: US 2007/0175339 A1
(43) Pub. Date: Aug. 2, 2007

(54) Mold structure for pressing fruits and vegetables

(76) Inventor: Fu-Yin Su, Tainan-City (TW)

Correspondence Address: Fu-Yin Su, No.2, Alley 492, Hai Tien Rd. Sec. 2, Tainan City, 709, TW

(21) Appl. No.: 11/342,026

(22) Filed: Jan. 30, 2006

(51) Int. Cl. A47J 37/12

(52) U.S. Cl. 99/353

(57) ABSTRACT

This invention is called “Mold Structure for Pressing Fruits and Vegetables.” It comprises an upper mold and a lower mold to form a hollow container. The walls of the container contain an engraving of a design or lettering, so an unripe fruit/vegetable placed inside the container will be pressed by the mold as it ripens assuming the shape of the mold, and the attractive design or lettering will be impressed onto the fruit/vegetable.

### FIELD OF THE INVENTION

The present invention relates to a mold structure for pressing fruits and vegetables.

### BACKGROUND OF THE INVENTION

As technology advances, humans have increased efforts in improving the uses of fruits and vegetables. These efforts have made dramatic changes in improving the genetics, growth technology, and appearance of fruits and vegetables. Currently the trend is in modifying the appearance of fruits and vegetables in the melon family, which includes the all familiar watermelon, and extends to many other fruits and vegetables. More specifically, the established method for modifying fruit and vegetable appearance combines various back plates and/or molds to secure the unripe fruit/vegetable, and let the fruit/vegetable take on the desired shape and appearance after it ripens. But the biggest disadvantages of the established method are the fruits and vegetables of the same shape and appearance cannot be consistently produced by this method, and the shaping molds cannot be reused.

Nevertheless, the mold structure is an improved application of the established method based on the inventor's many years of industry experience, a reusable fruit/vegetable mold. The following illustrations will help the Examining Committee to better understand this invention. The present invention comprises an upper mode (1), a lower mold (2), connector rods (3) and a top cover (4).

The upper mold (1) is hemispherical, hollow underneath, and there can be a design or lettering engraved on its inner wall. The upper mold extends into enclosure tabs (11). On the upper mold (1) there are many cylindrical protrusions (12). The protrusions (12) are hollow to receive the connector rods (13). On the two ends of the upper mold (1) there are hemispherical air holes (14).

The lower mold (2) is shaped exactly opposite the upper mold (1). It is hollow on top, and the inner wall can be engraved with a design or lettering. The lower mold extends into enclosure tabs (21) that fit with those of the upper mold (11). Each lower enclosure tab (21) has a clasp (22). The bottom of the lower mold (2) has cylindrical protrusions (23). The protrusions (23) are hollow (24) to receive connector rods. On the two ends of the lower mold (2) there are hemispherical air holes (25).

The connector rods (3) are cylindrical which is to be plugged into the protrusions.

The top cover (4) looks like a roof, with many holes to connect with connector rods (41).

The present invention can be used on fruits and vegetables with hard shells, such as watermelons, pumpkins, cucumbers and so on. The unripe fruits and vegetables placed inside the container will be pressed by the mold as it ripens assuming the shape of the mold, and the attractive design or lettering will be pressed onto the fruits and vegetables.

MAJOR COMPONENTS

| | | |
|---|---|---|
| 1. upper mold | 11. enclosure tab | 12. protrusion |
| 13. connector hole | 14. air hole | 2. lower mold |
| 21. enclosure tab | 22. locking clasp | 23. protrusion |
| 24. connector hole | 25. air hole | 3. connector rod |
| 4. top cover | 41. connector hole | 5. container |

### BRIEF DESCRIPTION OF THE DRAWINGS

FIG. 1 is a dissection of the three-dimensional drawing of the present invention.

FIG. 2 is a three-dimensional assembly drawing of the present invention.

FIG. 3 is cross-sectional drawing of the present invention.

FIG. 4 is an implementation illustration of the present invention.

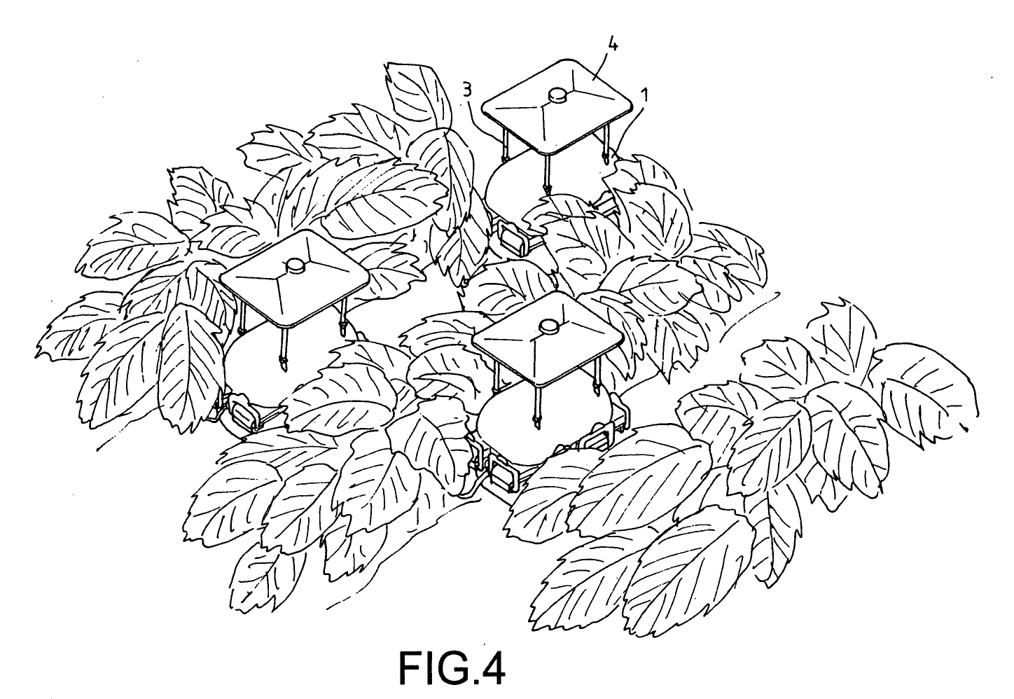

FIG. 5 is a schematic drawing of the present invention.

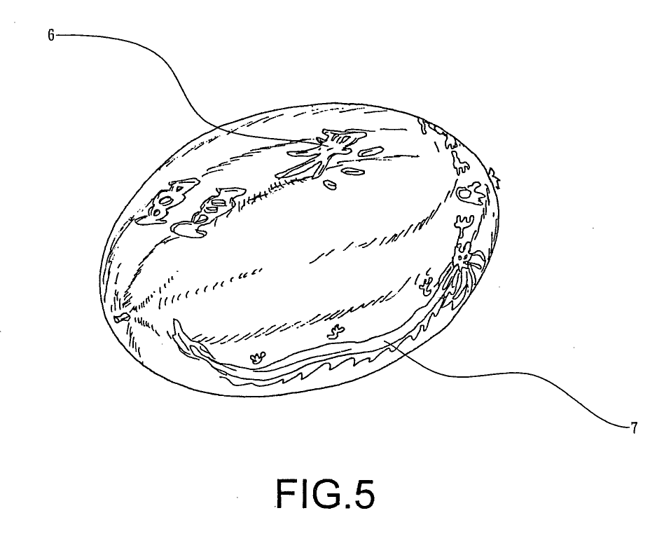

### DETAILED DESCRIPTION OF THE INVENTION

The mold structure is an improved application of the established method based on the inventor's many years of industry experience, to be a reusable fruit/vegetable mold. The following illustrations will help the Examining Committee to better understand this invention.

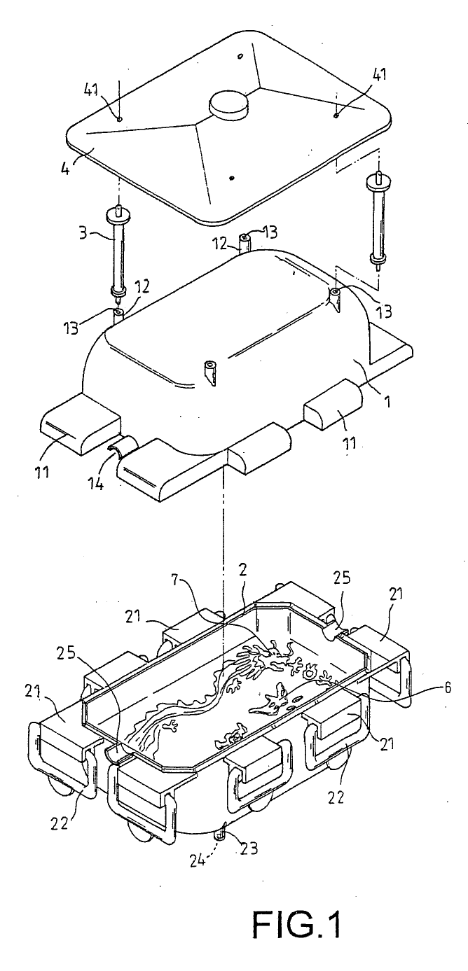

In FIG. 1, the mold structure is formed by an upper mold (1), a lower mold (2), connector rods (3) and a top cover (4).

The upper mold (1) is hemispherical, hollow underneath, and there can be a design or lettering engraved on its inner wall. The upper mold extends into enclosure tabs (11). On the upper mold (1) there are many cylindrical protrusions (12). The protrusions (12) are hollow to receive the connector rods (13). On the two ends of the upper mold (1) there are hemispherical air holes (14).

The lower mold (2) is shaped exactly opposite the upper mold (1). It is hollow on top, and the inner wall can be engraved with a design or lettering. The lower mold extends into enclosure tabs (21) that fit with those of the upper mold (11). Each lower enclosure tab (21) has a clasp (22). The bottom of the lower mold (2) has cylindrical protrusions (23). The protrusions (23) are hollow (24) to receive connector rods. On the two ends of the lower mold (2) there are hemispherical air holes (25).

The connector rods (3) are cylindrical which are to be plugged into the protrusions.

The top cover (4) looks like a roof, with many holes to connect with connector rods (41).

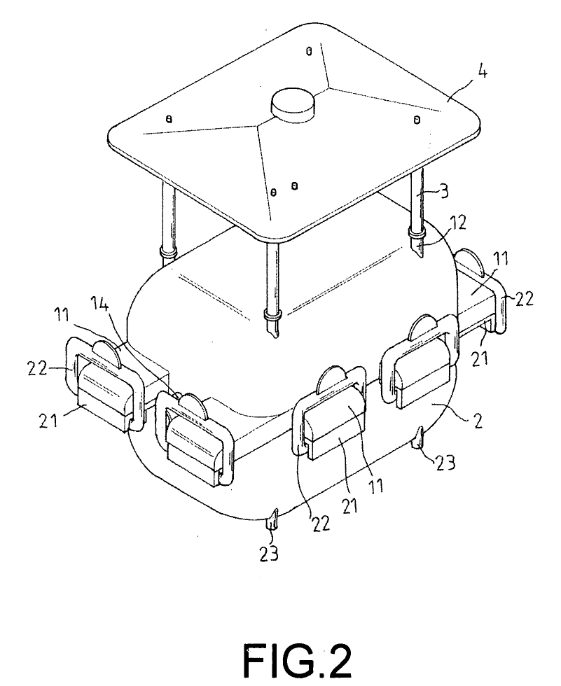

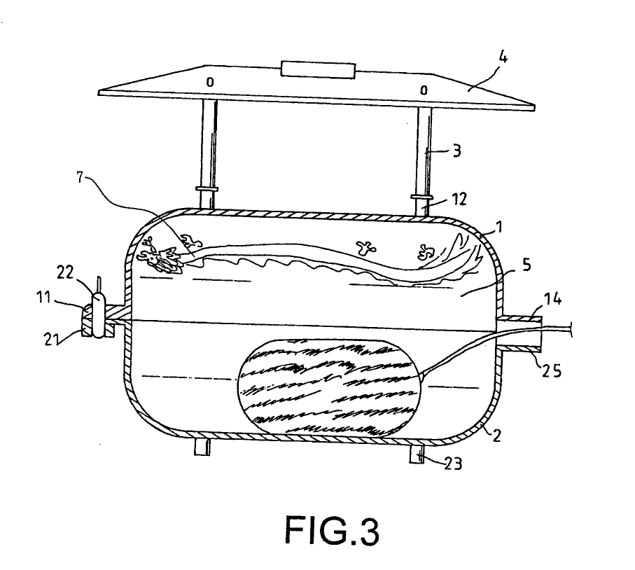

As seen in FIG. 2, the mold structure uses the upper mold (1) and lower mold (2) to form a hollow container (5). An unripe fruit/vegetable is placed in the hollow (5), and its stems go through the air holes (14, 25) formed by the upper mold (1) and lower mold (2). Then the clasp (22) of the lower mold (2) is closed over the enclosure tab (11) of the upper mold (1). The connector rod (3) is plugged into the hole (13) on top of the upper mold (1), and the top cover (4) is added to the structure by plugging the connector rods (3) into the top cover's holes (41) (see FIG. 3)

The bottom of the lower mold (2) also has protrusions (23) with holes (24), which can accept connector rods (3). This allows the upper (1) and lower (2) molds to be flipped upside down, and the cover (4) can be placed on top of the lower mold.

The merits of this invention are described as following:

1. The upper (1) and lower (2) molds can be reused, thus saving on costs.

2. The engraved design/lettering in the container will make the fruits/vegetables look more attractive.

3. The top cover (4) protects the fruit/vegetable inside the mold from harsh weather conditions.

In summary, the invention of this mold structure has met the standard for patent application. Thus this application has been submitted in the hope of being approved by the Examining Committee.

1. (canceled)

2. (canceled)

3. The mold structure of claim 5 wherein the design or letterings are engraved on the inner surface of the mold and make the fruits or vegetables be pressed with the design or letterings on the appearance while growing up in the container.

4. The mold structure of claim 5 wherein the container is disposed with mainly the unripe fruit or vegetables instead of ripe ones.

5. A mold structure for fruits or vegetables comprising:
an upper mold combined with the lower mold forming a hollow container in the central having sufficient size of cavity permitting the unripe fruit or vegetables be disposed inside growing up, a plurality of locking clasps disposed on the lower mold are used to lock with the enclosure tabs which extend from the upper mold for fastening the upper and lower mold together, forming two air holes separately in the middle of two molds enabling the stems of the unripe fruit or vegetables going through, the connector rods plugged into the hollow protrusions both of the upper and lower mold and also the holes on the top cover as to fasten the top cover onto the mold.
